(19) United States
(12) Patent Application Publication
(10) Pub. No.: US 2009/0075235 A1
(43) Pub. Date: Mar. 19, 2009

(54) Fixed, Implant-Supported, Full Arch Dental Prosthetics and Methods of Seating Thereof

(76) Inventor: William F. Letcher, Tulsa, OK (US)

Correspondence Address: HEAD, JOHNSON & KACHIGIAN, 228 W 17TH PLACE, TULSA, OK, 74119, US

(21) Appl. No.: 12/277,899

(22) Filed: Nov. 25, 2008

Related U.S. Application Data
(63) Continuation-in-part of application No. 12/237,133, filed on Sep. 24, 2008.
Application No. 12/237,133 is a continuation-in-part of application No. 11/734,138, filed on Apr. 11, 2007.
(60) Provisional application No. 60/863,232, filed on Oct. 27, 2006.

(51) Int. Cl. A61C 8/00; A61C 13/00

(52) U.S. Cl. 433/173; 433/215

(57) ABSTRACT

A fixed, implant-supported, full arch dental prosthetic having a dental prosthetic body, a rigid fence and a gingival veneer. The dental prosthetic body is prefabricated from a cured dental resin, and the rigid fence and the gingival veneer are respectively constructed from a curable dental resin. The dental prosthetic body, which can be included in a dental kit, may be prefabricated in various shapes and sizes and with various tooth forms. The dental kit also contains a supply of at least one curable dental resin, such as for constructing the rigid fence and/or the gingival veneer of the dental prosthetic and/or for affixing the dental prosthetic to an array of dental implants embedded in a patient's mouth.

### CROSS-REFERENCE TO RELATED APPLICATIONS

This application is a continuation-in-part of U.S. patent application Ser. No. 12/237,133, filed Sep. 24, 2008, and is a continuation-in-part of U.S. patent application Ser. No. 11/734,138, filed Apr. 11, 2007, which claim priority to U.S. Provisional Application No. 60/863,232, filed Oct. 27, 2006, all of which are incorporated herein by reference.

### BACKGROUND OF THE INVENTION

1. Field of the Invention

This invention relates generally to a fixed, implant-supported, full arch dental prosthetics and methods of seating thereof, and more particularly to a fixed, full arch dental prosthetic to be supported by and permanently attached to an array of dental implants embedded in a patient's jaw, a method of supporting and permanently attaching the dental prosthetic to the array of dental implants and dental kits containing the dental prosthetic and materials for supporting and permanently attaching the dental prosthetic to the array of dental implants embedded in the patient's mouth.

2. Description of the Related Art

For persons who have lost an appreciable number of their natural teeth, whether due to disease, decay or other natural or unnatural processes, there is likely to be significant social withdrawal, shame, humiliation and a corresponding loss of dignity. While prosthodontic medicine has greatly enhanced the quality of life of such person's artificial or prosthetic teeth, there remains room for improvement. Traditional dentures, for example, have evolved and undergone substantial improvement in appearance as well as function. However, persons wearing traditional dentures still face a number of problems, including progressive bone loss, inadequate adhesion, poor fit, slippage, unwanted movement, general discomfort, adverse psychological effects, infiltration of food particles, and maintenance.

While composite resin has long been recognized as a useful tooth filling material for anterior or posterior restorations, it has not yet found its way into implant supported prosthodontic applications, such as fixed, implant-supported full arch dental prosthetics. The benefits of resin over prior art materials such as acrylics, ceramics and porcelain are numerous. Unlike a dental prosthetic made from porcelain, a dental prosthetic constructed from a dental resin is amenable to modifications, such as the addition or removal of material for both aesthetic and functional reasons, using a myriad of filling and drilling techniques even after fully cured and even after the dental prosthetic is in place. This enables a practitioner to make a number of adjustments to accommodate unforeseen or unexpected situations that simply cannot be anticipated through the use of cast molds in the laboratory. Further, resin is available in a number of color variants to aid in the aesthetics of the dental prosthetic. Resin may be cured typically in a matter of minutes, as opposed to oven-baking porcelain.

It is therefore desirable to provide a fixed, implant-supported, full arch dental prosthetic, such as in a dental kit, and methods of seating thereof that enable a practitioner to provide patients with a long-term, durable, fixed, implant-supported full arch dental prosthetic that can be achieved with minimal disruption or inconvenience.

It is further desirable to provide a fixed, implant-supported, full arch dental prosthetic and methods of seating thereof that utilize a curable dental resin to construct a rigid resin fence for supporting and permanently affixing the dental prosthetic to an array of dental implants embedded in a patient's jaw.

It is still further desirable to provide a fixed, implant-supported, full arch dental prosthetic and methods of seating thereof that are both functionally, aesthetically and procedurally superior to prior prosthodontia.

It is yet further desirable to provide a fixed, implant-supported, full arch dental prosthetic and methods of seating thereof that may be applied to any situation in which one or more dental prosthetics are required, such as a fixed, full dental prosthetic for replacement of patient's maxillary arch and/or mandibular arch.

It is yet further desirable to provide a fixed, implant-supported, full arch dental prosthetic and methods of seating thereof wherein a prefabricated dental prosthetic body is securely affixed to a rigid resin fence for forming, supporting and permanently affixing the dental prosthetic to an array of dental implants embedded in a patient's jaw, thus eliminating the need for O-rings, cements, screws, clasps, clips, fasteners, metal frameworks or other mounting methods and devices currently employed.

It is yet further desirable to provide a fixed, implant-supported, full arch dental prosthetic and methods of seating thereof that eliminate the problems patients experience with slippage and unwanted movement.

It is yet further desirable to provide a fixed, implant-supported, full arch dental prosthetic and methods of seating thereof whereby the patient can have the dental prosthetic prepared, finished and seated during the same surgical office visit as the placement of the dental implants.

It is yet further desirable to provide a fixed, implant-supported, full arch dental prosthetic and methods of seating thereof that eliminates the cost and inconvenience of having to send molds to a third-party, offsite laboratory, thereby maximizing the efficiency and minimizing the disruption to the patient, such as having to make multiple return trips.

It is yet further desirable to provide a fixed, implant-supported, full arch dental prosthetic and methods of seating thereof wherein a clearance is provided between the dental prosthetic and the gingival soft tissues of the patient's mouth, thereby enabling the patient to maintain good oral hygiene.

### SUMMARY OF THE INVENTION

In general, in a first aspect, the invention relates to a fixed, implant-supported, full arch dental prosthetic having a rigid, full arch dental prosthetic body prefabricated from a cured dental resin. The prosthetic body has a dentate portion, a terminal occlusal surface and a terminal intaglio surface. The prosthetic body may further include a gingival flange intermediate of the dentate portion and the intaglio surface. The dental prosthetic also has a rigid fence constructed from the cured dental resin and affixed to the intaglio surface of the prosthetic body using the cured dental resin. The fence includes a plurality of implant sockets corresponding and affixed to an array of dental implants embedded into a patient's jaw using the cured dental resin. Each of the dental implants has a head portion exposed above a patient's gingival tissue and a threaded shank portion embedded and anchored within the patient's jawbone. The fence is constructed such that the implant sockets have a depth less than a length of the head portion of the dental implant, thereby providing a clearance between the dental prosthetic and the patient's gingival tissue.

The dental prosthetic may further include a gingival veneer constructed from the cured dental resin and blended, finished and affixed to the prosthetic body and the rigid fence. The prosthetic body, the rigid fence and the gingival veneer form a unitary, fixed, implant-supported, full arch dental prosthetic. Further, the gingival veneer may include a gingival shade. In addition, the gingival veneer of the dental prosthetic may be tapered in order to increase the clearance between the dental prosthetic and the patient's gingival tissue. The cured dental resin may be a composite resin, a hybrid composite resin, a nanohybrid composite resin, a micro-filled composite resin, a flowable composite resin, an unfilled resin or combination thereof.

In general, in a second aspect, the invention relates to a full arch dental prosthetic for a patient having an array of embedded dental implants, where the dental implants each have a head portion exposed above the patient's gingival tissue and a threaded shank portion embedded and anchored within the patient's jawbone. The dental prosthetic includes a prefabricated, rigid, full arch dental prosthetic body having a dentate portion, a terminal occlusal surface and a terminal intaglio surface. The dental prosthetic also includes a rigid resin fence affixed to the intaglio surface of the prosthetic body. The rigid fence has a plurality of implant sockets corresponding to the array of dental implants, and each of the implant sockets has a depth less than a length of the head portion of the dental implant embedded into the patient's jaw. The dental prosthetic further may further include a gingival veneer affixed to the prosthetic body and the rigid fence.

The rigid fence may be firmly affixed to the intaglio surface of the prosthetic body and the implant sockets may be affixable to the array of dental implants embedded into the patient's jaw, both using a curable dental resin. The prosthetic body, the rigid fence and the gingival veneer are blended and finished to form a unitary, fixed, implant-supported, full arch dental prosthetic. Additionally, the gingival veneer may include a gingival shade. The gingival veneer can be tapered in order to increase a clearance between the dental prosthetic and the patient's gingival tissue.

In general, in a third aspect, the invention relates to a dental kit having at least one prefabricated, rigid, full arch dental prosthetic body being arcuate in form and constructed of a cured dental resin. The prosthetic body has a dentate portion, a terminal occlusal surface and a terminal intaglio surface. A supply of a curable dental resin is also provided with the dental kit. The dental prosthetic body may be a plurality of dental prosthetic bodies having varying shapes and sizes. Further, the dentate portions of the plurality of dental prosthetic bodies may have varying tooth shapes and forms. The prosthetic body may further include a gingival flange intermediate of the dentate portion and the intaglio surface. The dental kit may also include a supply of an unfilled, curable dental resin, at least one implant analog, at least one dental implant having a head portion and a threaded shank portion, a supply of wax, a supply of shellac or a combination thereof.

In general, in a fourth aspect, the invention relates to a method of permanently attaching a full arch dental prosthetic to an array of dental implants embedded into a patient's jaw, comprising the steps of (a) selecting a prefabricated, rigid, full arch dental prosthetic body having a dentate portion, a terminal occlusal surface and a terminal intaglio surface; (b) constructing a resin fence along an array of implant analogs on a working model, where the resin fence includes a plurality of implant sockets; (c) curing the resin fence; (d) affixing the resin fence to the intaglio surface of the dental prosthetic body; and (e) affixing the implant sockets of the dental prosthetic to the array of dental implants embedded in the patient's jaw. The resin fence may be constructed from a curable dental resin and the implant sockets of the dental prosthetic may be affixed to the array of dental implants using a curable dental resin. The method may further include constructing and curing a gingival veneer from a curable dental resin along the resin fence and the prosthetic body. In addition, the dental prosthetic body, the resin fence and the gingival veneer may be blended and finished

### BRIEF DESCRIPTION OF THE DRAWINGS

FIG. 1 is a perspective view of an example of a fixed, implant-supported, full arch dental prosthetic in accordance with an illustrative embodiment of the fixed, implant-supported, full arch dental prosthetic, kits and methods of seating thereof disclosed herein;

FIG. 2 is a bottom perspective view of the fixed, implant-supported, full arch dental prosthetic shown in FIG. 1;

FIG. 3a is a cross-sectional view along line 3-3 of the fixed, implant-supported, full arch dental prosthetic shown in FIG. 1, wherein the intaglio surface of the dental prosthetic is substantially concave;

FIG. 3b is a cross-sectional view along line 3-3 of the fixed, implant-supported, full arch dental prosthetic shown in FIG. 1, wherein the intaglio surface of the dental prosthetic is substantially planar;

FIG. 3c is a cross-sectional view along line 3-3 of the fixed, implant-supported, full arch dental prosthetic shown in FIG. 1, wherein the intaglio surface of the dental prosthetic is substantially convex;

FIG. 4 is a perspective view of a working model having a sub-fence, which are encapsulated by a separating mold in accordance with an illustrative embodiment of the fixed, implant-supported, full arch dental prosthetic, kits and methods of seating thereof disclosed herein;

FIG. 5 is a perspective view of the working model of FIG. 4 having a rigid fence constructed thereon in accordance with an illustrative embodiment of the fixed, implant-supported, full arch dental prosthetic, kits and methods of seating thereof disclosed herein;

FIG. 6 is a cross-sectional view along line 6-6 of the working model and the rigid fence of FIG. 5;

FIG. 7 is a perspective view of a patient's mouth having a shellac baseplate, a wax buildup and a dental prosthetic body placed therein for alignment and orientation in accordance with an illustrative embodiment of the fixed, implant-supported, full arch dental prosthetic, kits and methods of seating thereof disclosed herein;

FIG. 8 is a perspective view of a patient's mouth having a functional arch opposing a dental prosthetic body for determining the necessary height of a rigid fence in accordance with an illustrative embodiment of the fixed, implant-supported, full arch dental prosthetic, kits and methods of seating thereof disclosed herein; and

FIG. 9 is a perspective view of aligning and orienting a functional arch and a dental prosthetic body using an alignment jig in accordance with an illustrative embodiment of the fixed, implant-supported, full arch dental prosthetic, kits and methods of seating thereof disclosed herein.

Other advantages and features will be apparent from the following description, and from the claims.

### DETAILED DESCRIPTION OF THE INVENTION

The apparatuses and methods discussed herein are merely illustrative of specific manners in which to make and use this invention and are not to be interpreted as limiting in scope.

While the apparatuses and methods have been described with a certain degree of particularity, it is to be noted that many modifications may be made in the details of the construction and the arrangement of the apparatuses and components without departing from the spirit and scope of this disclosure. It is understood that the apparatuses and methods are not limited to the embodiments set forth herein for purposes of exemplification.

For purposes of illustration and exemplification, a fixed, implant-supported, full arch dental prosthetic, dental kits and methods of seating thereof are shown and described herein with reference to a fully edentulous patient requiring a maxillary and/or a mandibular fixed, full arch dental prosthetic, but should not be so limited to such a class of patients. The fixed, implant-supported, full arch dental prosthetic, dental kits and methods of seating thereof may be used and/or performed on other classes of patients, such as partially dentate patients requiring either a full mandibular arch or a full maxillary arch fixed, implant-supported dental prosthetic. Other classes of patients may require that one or more diseased or malpositioned teeth be extracted before prosthodontic treatment may proceed.

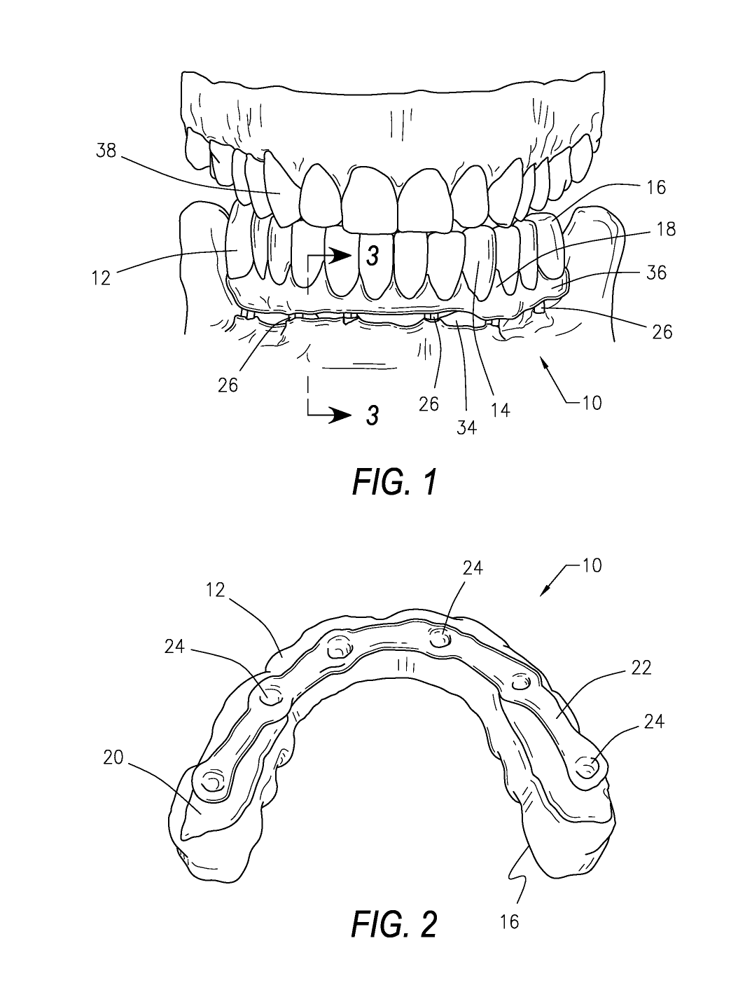

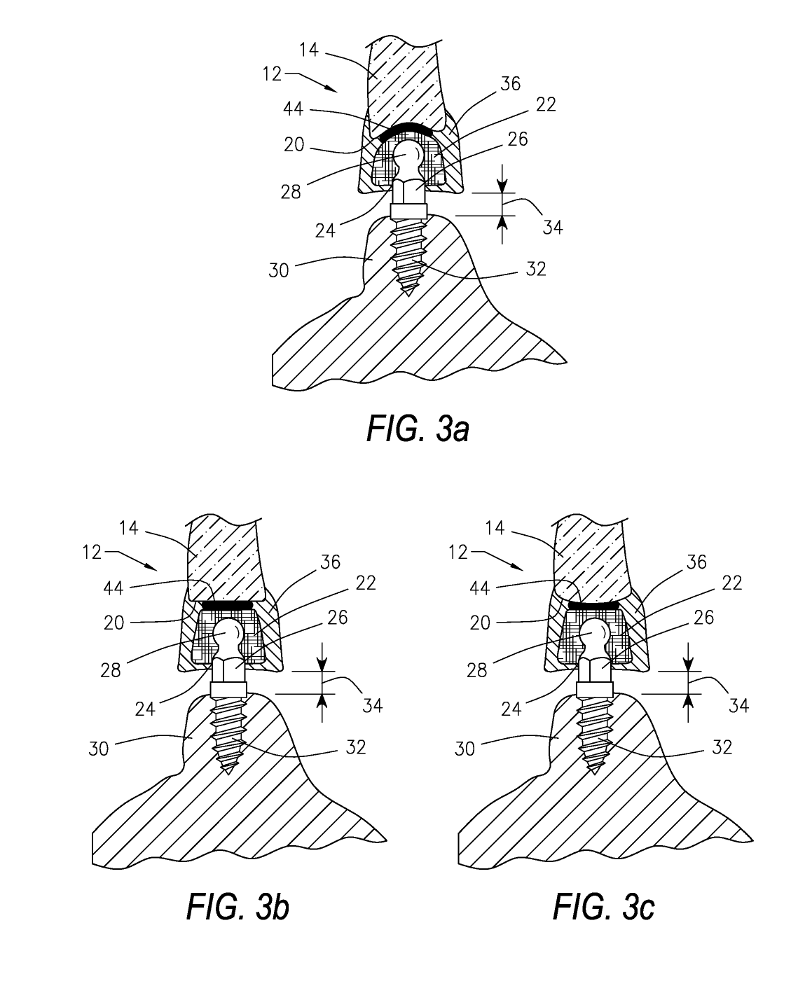

Referring to the figures of the drawings, wherein like numerals of reference designate like elements throughout the several views, and initially to FIGS. 1 and 2, the fixed, implant-supported, full arch dental prosthetic 10 includes a prefabricated dental prosthetic body 12 having a dentate portion 14, a terminal occlusal surface 16 and a terminal intaglio surface 20. The dental prosthetic body 12 may also include a gingival flange 18 intermediate of the dentate portion 14 and the terminal intaglio surface 20. The intaglio surface 20 of the dental prosthetic body 12 may be concave (FIG. 3a), planar (FIG. 3b), convex (FIG. 3c) or other suitable shape. The dental prosthetic body 12 may be prefabricated in varying sizes to accommodate different sizes of mouths; for example, the dental prosthetic body 12 may come in small, medium and large sizes. The dental prosthetic body 12 may also be prefabricated with the dentate portion 14 having varying tooth shapes, sizes and styles allowing the practitioner to select the dental prosthetic body 12 to aesthetically compliment the patient's face. For example, patients with round faces may be provided with a dental prosthetic body 12 having a dentate portion 14 with round, ovoid teeth, while patients having rectangular faces may be provided with a dental prosthetic body 12 having a dentate portion 14 with square tapering teeth. Further, the dental prosthetic body 12 may be selected from a dental kit (not shown) having at least one dental prosthetic body 12. The dental prosthetic body 12 may be fabricated from a cured dental resin using standard dental methods and processes or may be fabricated using the methods and processes disclosed in Applicant's co-pending patent applications, Ser. Nos. 12/237,133 and/or 11/734,138, which are incorporated herein by reference.

The dental prosthetic 10 also includes a rigid fence 22 constructed from a curable dental resin and affixed to the intaglio surface 20 of the dental prosthetic body 12. The rigid fence 22 may be constructed and cured using the chair side methods and techniques fully described below. The rigid fence 22 includes a plurality of implant sockets 24 that correspond to and are affixable to an array of dental implants 26 embedded in a patient's mandibular arch and/or maxillary arch using a curable dental resin 44. A supply of the dental resin (not shown) may be included in the dental kit for use in constructing the rigid fence 22 and affixing the rigid fence 22 to the array of dental implants 26 embedded in the patient's mouth.

The dental implants 26 embedded in the patient's mandibular arch and/or maxillary arch may be traditional dental implants or may be mini dental implants placed in a patient who has a severely atrophied jawbone for which traditional dental implants cannot be placed because of the physical limitations of the patient. The mini dental implants, such as MDL™ mini-implants (INTRA-LOCK INTERNATIONAL, INC., Boca Raton, Fla.), may have a diameter of approximately two (2) millimeters to approximately two and a half (2.5) millimeters. The number of dental implants 26 embedded in the patient's mouth may vary depending upon the particular needs of the individual patient. For example, if the patient is edentulous and has no prior dental implants, a total of eight (8) to twelve (12) dental implants may be surgically embedded for full mandibular and maxillary arch replacements. The dental implants 26 may be constructed of any suitable material, such as a titanium alloy allowing for osseointegration. Further, the dental implants 26 may be a screw-type dental implant having a head portion 28 that is exposed above the patient's gingival tissue 30 and a threaded shank portion 32 that is embedded and anchored within the patient's jawbone. The implant sockets 24 of the rigid fence 22 have a depth less than a length of the exposed head portion 28 of the dental implants 26 for supporting the dental prosthetic 10 away from the gingival tissue 30 of the patient's mouth (i.e. a clearance 34). The clearance 34 between the rigid fence 22 of the dental prosthetic 10 and the patient's gingival tissue 30 may be less than approximately four (4) millimeters, thereby allowing the patient to maintain good oral hygiene, such as by allowing cleansing with a toothbrush or a water-irrigating device intermediate of the dental prosthetic 10 and the patient's gingival tissue 30.

The dental prosthetic 10 may further includes a gingival veneer 36 for blending, finishing and further affixing the rigid fence 22 to the dental prosthetic body 12. The gingival veneer 36 is constructed from a curable dental resin, a supply of which may be included in the dental kit. The gingival veneer 36 may be complimented with a gingival shade to make the dental prosthetic 10 more esthetically pleasing and truthful in the patient's mouth. The gingival veneer 36 may also be tapered and/or trimmed in order to increase the clearance 34 between the rigid fence 22 and the patient's gingival tissue 30. The dental prosthetic 10 may be further finished by refining, shaping and/or polishing using dental laboratory tools and prosthodontic techniques for both aesthetic (e.g., tooth shape, separation and definition) and functional (e.g., bite refinements, removing excess bulk to ensure patient comfort) purposes.

The practitioner selects an appropriate prefabricated dental prosthetic body 12, such as from the dental kit, based upon his or her professional judgment. In order to orient the dental prosthetic body 12 with an opposing arch 38 of a fully edentulous patient and to determine the desired height of the rigid fence 22, a shellac baseplate 40 and a wax buildup 42 may be utilized, as further described herein. A study model (not shown) of the patient's mouth may be created from an impression of the patient's maxillary arch and/or mandibular arch without any removable, partial or full dentures in place. As is standard in the dental industry, the impression is formed by placing a soft pliable material into a holder shaped to accommodate the maxillary arch or the mandibular arch of the patient. After the holder having the impression material therein is pressed around the patient's gingiva, it is removed and a dental stone, such as plaster, is poured into the impression, resulting in the study mold of the patient's mouth. The shellac baseplate 40 is molded onto a gingival line of the study model, and the wax buildup 42 is added to the baseplate 40 to approximate the proper length and position of the teeth that are missing from the patient's mouth. The wax buildup 42 is also formed to imitate the support typically provided by natural dentition to the patient's lips. The wax buildup 42 may include a substantially planar occlusal surface 48. A wax bite registration (not shown) may be taken in order to capture the vertical and centric registration of the patient. The practitioner can then mount and orient the study model with the baseplate 40 and the wax buildup 42 on an articulator (not shown). The occlusal surface 16 of the dental prosthetic body 12 is aligned with the occlusal surface 48 of the wax buildup 42 to determine the necessary height required for the rigid fence 22, as illustrated in FIG. 7.

For patients with functioning opposing arches 38, such as natural teeth, a denture or the dental prosthetic 10 disclosed herein, the occlusal surface 16 of the dental prosthetic body 12 is aligned with the occlusal surface 62 of the opposing arch 38 of the patient in order to determine the necessary height of the rigid fence 22. With the necessary height determined, the rigid fence 22 may be constructed on a working model 50.

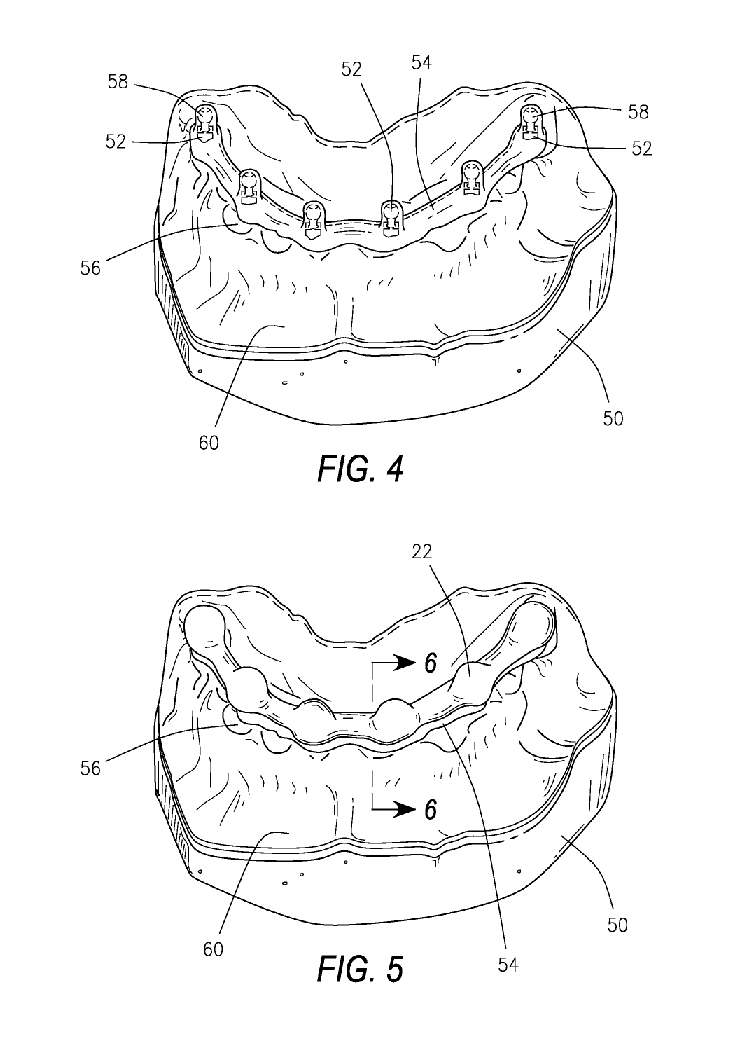

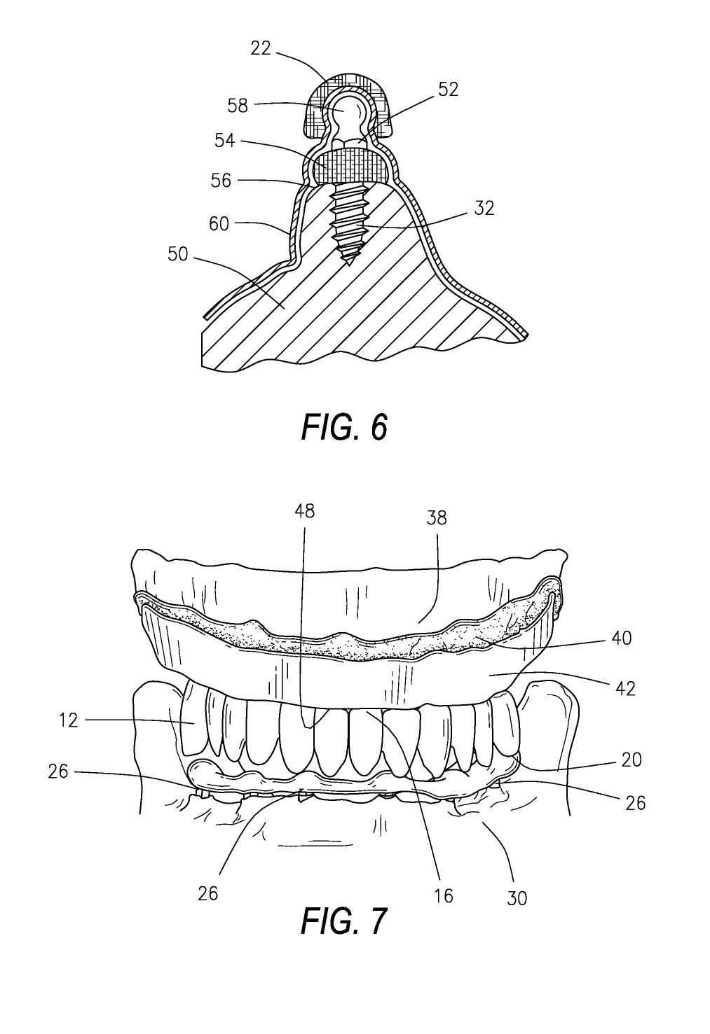

A full arch alginate impression of the patient's maxillary and/or mandibular arches may be made after the array of dental implants 26 is surgically embedded in the patient's mouth. Implant analogs 52, such as MDL™ Laboratory Analogs (INTRA-LOCK INTERNATIONAL, INC., Boca Raton, Fla.), are placed into the impression to replicate the dental implants 26 embedded in the patient's mouth. A dental stone, such as plaster, is then poured into the impression to form the working model 50, as shown in FIGS. 4 and 5. A sub-fence 54 may be formed along a gingival line 56 of the working model 50 using any suitable dental material, such as wax or resin. The sub-fence 54 has a height less than the length of an exposed head portion 58 of the implant analogs 52. A thin sheet of separating film may then be adapted to the working model to form a separating mold 60. The working model 50 is placed onto a bed of granular material resting on a platform of a positive pressure device (not shown). The thin sheet of separating film, such as Isofolan™ (SCHEU-DENTAL, Germany), is placed over the working model 50, which by application of heat and air pressure is forced to closely conform to the exterior configuration of the working model 50, including the implant analogs 52 and the sub-fence 54, as illustrated in FIGS. 4 and 6. The thin sheet of separating film may be transparent, translucent or opaque and may have any desirable thickness, such as 0.1 millimeters. The thin sheet of separating film prevents the dental resin used to form the rigid fence 22 from bonding or sticking to the working model 50. FIG. 4 shows the thin sheet of separating film having been heated and forced by air pressure to closely adhere to the external configuration of the working model 50 to form the separating mold 60. Once the thin sheet of separating film has cooled thereby forming the separating mold 60, the air pressure can be released and the working model 50 and the separating mold 60 may be removed from the positive pressure device.

With respect to FIG. 5, the rigid fence 22 is built along the gingival line 56 of the working model 50 using a curable dental resin, such as Renamel (Cosmedent, Chicago, Ill.). The dental resin may be provided in the dental kit and may be dispensed from a suitable dispenser, such as a syringe provided by the manufacturer. The rigid fence 22 is typically built manually, but one or more appliances or tools could be utilized for molding, shaping, etc. The rigid fence 22 effectively connects and conceals implant analogs 52 of the working model 50, forming a single, unitary structure.

The implant analogs 52 of the working model 50 form the plurality of implant sockets 24 in the rigid fence 22. The implant sockets 24 correspond to and are affixable to the array of dental implants 26 embedded in a patient's mandibular arch and/or maxillary arch. The sub-fence 54 formed along the gingival line 56 of the working model 50 and having a height less than the length of the exposed head portion 58 of the implant analogs 52, results in the implant sockets 24 of the rigid fence 22 having a depth less than the length of the exposed head portion 58 of the implant analogs 52 (and as a result less than a length of the exposed head portion 28 of the dental implants 26) for supporting the dental prosthetic 10 away from the gingival tissue 30 of the patient's mouth, i.e., the clearance 34. The separating mold 60 closely adhering to the external configuration of the working model 50 prevents the dental resin used to form the rigid fence 22 from bonding or sticking to the working model 50. FIG. 6 is a cross-section depicting the erection of the rigid fence 22 about the implant analogs 52 and along the gingival line 56 of the working model 50. The rigid fence 22 may be constructed in a serpentine fashion or with undulations to ensure a continuous, unitary structure if the implant analogs 52 (and the array of dental implants 26) are not embedded in parallel in the patient's jaw bone. Once constructed, the rigid fence 22 is cured. For example, the rigid fence 22 may be cured by subjecting it to an external light source (not shown), such as a handheld LED curing light, by self-curing or by curing using other readily available means, such as external heat. Once cured, the rigid fence 22 is removed from the working model 50 and seated on the array of dental implants 26 embedded in the patient's jawbone.

For fully edentulous patients and as illustrated in FIG. 7, the shellac baseplate 40 and the wax buildup 42 are placed in the patient's mouth on the arch opposing 38 the rigid fence 22. The practitioner also places the dental prosthetic body 12 in the patient's mouth with the intaglio surface 20 aligned with the rigid fence 22 and the occlusal surface 16 aligned with the occlusal surface 48 of the wax buildup 42. Once satisfied with the alignment and placement of the dental prosthetic body 12, the practitioner has the patient bite down causing the occlusal surface 16 of the dental prosthetic body 12 to mate with and make an impression on the occlusal surface 48 of the wax buildup 42. A curable dental resin (not shown) is then applied to the intaglio surface 20 of the dental prosthetic body 12 and/or to a portion of the rigid fence 22 that mates with the intaglio surface 20 of the dental prosthetic body 12. For example, the dental resin may be placed on opposing posterior portions and on an anterior portion of the dental prosthetic body 12 or the rigid fence 22. With the occlusal surface 48 of the wax buildup 42 and the occlusal surface 16 of the dental prosthetic body 12 aligned, the practitioner may again have the patient bite down to seat the dental prosthetic body 12 onto the rigid fence 22 and then cure the dental resin to firmly affix the dental prosthetic body 12 to the rigid fence 22.

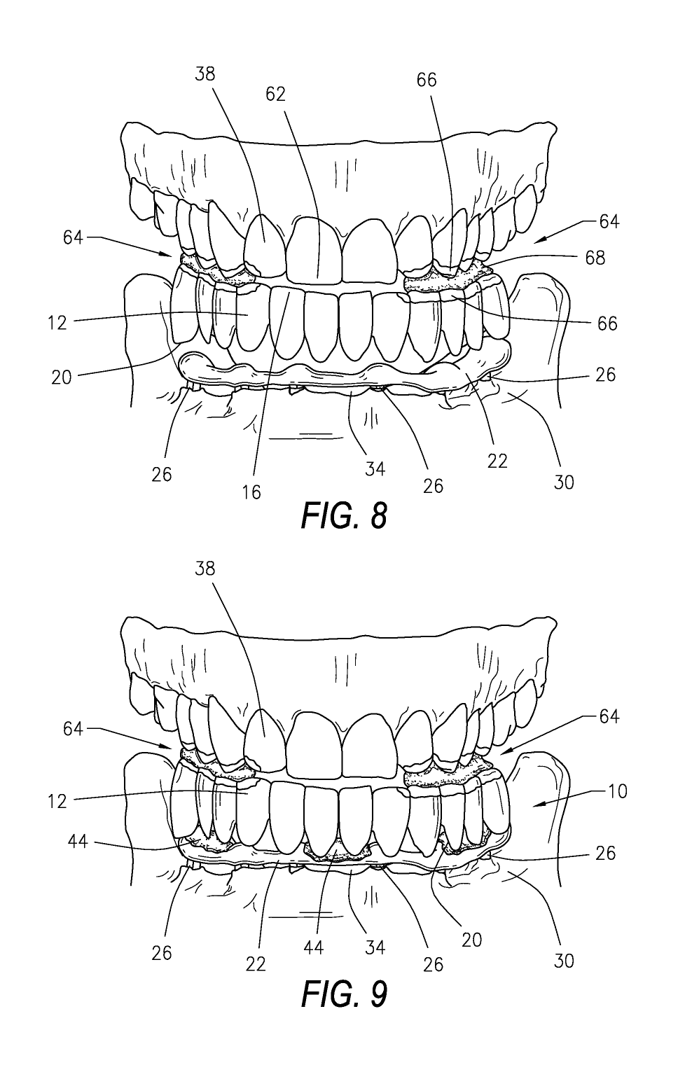

For patients with functioning opposing arches 38 and as illustrated in FIGS. 8 and 9, the dental prosthetic body 12 is placed in the patient's mouth and the intaglio surface 20 is aligned with the rigid fence 22, while the occlusal surface 16 is aligned with the occlusal surface 62 of the patient's opposing arch 38. Once satisfied with the alignment and placement of the dental prosthetic body 12, the practitioner may prepare an alignment jig 64 by applying a layer of a non-bonding material 66, such as a petroleum jelly, wax or other suitable dental material, on the occlusal surface 16 of the dental prosthetic body 12 and on the occlusal surface 62 of the opposing arch 38, as shown in FIGS. 8 and 9. A curable dental resin 68 may then be applied atop one or both of the layers of non-bonding material 66 and subsequently cured to form the alignment jig 64. The non-bonding material 66 prevents the dental resin 68 applied thereto from bonding or sticking to the dental prosthetic body 12 and/or the patient's opposing arch 38. The practitioner then has the patient bite down causing the occlusal surface 16 of the dental prosthetic body 12 to mate with the occlusal surface 62 of the opposing arch 38, and thereby forming the alignment jig 64 intermediate of the occlusal surfaces 16 and 62. A curable dental resin 44 is then applied to either the intaglio surface 20 of the dental prosthetic body 12 and/or to a portion of the rigid fence 22 that mates with the intaglio surface 20 of the dental prosthetic body 12. For example, the dental resin may be placed on opposing posterior portions and on an anterior portion of the dental prosthetic body 12 or the rigid fence 22. With the occlusal surfaces 62 and 16 of the opposing arch 38 and the dental prosthetic body 12 aligned and with the further aid of the alignment jig 64, the practitioner may again have the patient bite down to accurately seat the dental prosthetic body 12 onto the rigid fence 22. The dental resin is then cured to firmly affix the dental prosthetic body 12 to the rigid fence 22.

Once the rigid fence 22 and the dental prosthetic body 12 are firmly secured together, they may be removed from the patient's mouth. The gingival veneer 36 may be constructed along and affixed to the dental prosthetic body 12 and the rigid fence 22 to form the dental prosthetic 10. The gingival veneer 36 is constructed from a curable dental resin, and the resin veneer blends, finishes and further solidly affixes the dental prosthetic body 12 to the rigid fence 22. The dental prosthetic 10 may also be finished by further refining, shaping and/or polishing using dental laboratory tools and prosthodontic techniques for both aesthetic (e.g., tooth shape, separation and definition) and functional (e.g., bite refinements, removing excess bulk to ensure patient comfort) purposes. In addition, an unfilled curable dental resin, which may be supplied in the dental kit, can be used to further blend the dental prosthetic body 12, the rigid fence 22 and the gingival veneer 36. Further, a gingival shade may be added to the gingival veneer 36 (and the gingival flange 18, if utilized) of the dental prosthetic 10 to make it appear more esthetically pleasing and truthful in the patient's mouth.

In addition to the aforementioned blending and finishing and as shown in FIG. 1, the gingival veneer 36 of the dental prosthetic 10 may be further tapered and/or trimmed in order to increase the clearance 34 between the dental prosthetic 10 and the gingiva 30 of the patient's mouth. The clearance 34 may be approximately less than four (4) millimeters, thereby allowing the patient to maintain good oral hygiene, such as by allowing cleansing with a toothbrush or a water-irrigating device intermediate of the dental prosthetic 10 and the patient's gingiva 30.

An additional amount of a curable dental resin (not shown) is placed within the implant sockets 24 and the dental prosthetic 10 is seated directly onto the dental implants 26 embedded in the patient's jawbone. Any excess amount of the additional resin may be removed and the dental prosthetic 10 may be cured directly onto the dental implants 26. By placing the additional amount of the curable dental resin into the implant sockets 24, the dental prosthetic is rigidly seated directly and fixed onto the dental implants 26.

As noted herein, the dental kit includes at least one rigid, dental prosthetic body 12 prefabricated from a cured dental resin in varying shapes, sizes and tooth forms. The dental kit may also include a supply of at least one curable dental resin in order to form the rigid fence 22 and/or the gingival veneer 36 of the dental prosthetic 10. The curable dental resin may also be used in the implant sockets 24 of the dental prosthetic 10 when the practitioner affixes the dental prosthetic 10 to the array of dental implants 26 embedded in the patient's mouth. In addition, the dental kit can include a supply of an unfilled, curable dental resin to allow additional esthetic refinements and blending of the dental prosthetic. Yet further, the dental kit may include a supply of a suitable gingival shade, along with any other compositions and/or tools contemplated herein, including but not limited to at least one dental implant, at least one implant analog, shellac and/or wax.

The dental resins used herein, either in solitude or in combination, may be any curable dental resin, such as curable by light, heat, pressure or self-curing. In addition, dental resins used herein may be any moldable curable dental resins, including but not limited to a composite resin, a hybrid composite resin, a nanohybrid composite resin, a micro-filled composite resin or a flowable composite resin, such as Estelite® (TOKUYAMA CORP., Japan) or Renamel (Cosmedent, Chicago, Ill.) or an unfilled resin. Other suitable, curable materials, such as resin/glass ionomers, sculptable compomers and core buildup materials could also be utilized.

While the apparatuses and methods have been described in relation to the drawings and claims with a certain degree of particularity, it should be understood that other and further modifications, apart from those shown or suggested herein, may be made within the spirit and scope of this invention. It is understood that the apparatuses and methods are not limited to the embodiments set forth herein for purposes of exemplification, but is limited only by the scope of the attached claim or claims, including the full range of equivalency to which each element thereof is entitled.

What is claimed is:

1. A fixed, implant-supported, full arch dental prosthetic, comprising:
a rigid, full arch dental prosthetic body prefabricated from a cured dental resin; said prosthetic body having a dentate portion, a terminal occlusal surface and a terminal intaglio surface; and
a rigid fence constructed from said cured dental resin and firmly affixed to said intaglio surface of said prosthetic body using said cured dental resin; said fence having a plurality of implant sockets corresponding and firmly affixed to an array of dental implants embedded into a patient's jawbone; wherein each of said dental implants has a head portion exposed above said patient's gingival tissue and a threaded shank portion embedded and anchored within said patient's jawbone; wherein said implant sockets of said fence are constructed having a depth less than a length of said head portion of said dental implant; and wherein each of said implant sockets of said fence are firmly affixed to said head portion of said respective dental implant using said cured dental resin.

2. The dental prosthetic of claim 1 wherein said prosthetic body further comprises a gingival flange intermediate of said dentate portion and said intaglio surface.

3. The dental prosthetic of claim 1 further comprising a gingival veneer constructed from said cured dental resin and firmly affixed to said prosthetic body and said rigid fence.

4. The dental prosthetic of claim 3 wherein said prosthetic body, said rigid fence and said gingival veneer are blended and finished to form a unitary, fixed, implant-supported, full arch dental prosthetic.

5. The dental prosthetic of claim 3 wherein said gingival veneer includes a gingival shade.

6. The dental prosthetic of claim 1 further comprising a clearance between said dental prosthetic and said patient's gingival tissue.

7. The dental prosthetic of claim 3 wherein said gingival veneer is tapered in order to increase a clearance between said dental prosthetic and said patient's gingival tissue.

8. The dental prosthetic of claim 1 wherein said cured dental resin is a composite resin, a hybrid composite resin, a nanohybrid composite resin, a micro-filled composite resin, a flowable composite resin, an unfilled resin or a combination thereof.

9. A full arch dental prosthetic for a patient having an array of embedded dental implants, where said embedded dental implants each have a head portion exposed above said patient's gingival tissue and a threaded shank portion embedded and anchored within said patient's jawbone, said dental prosthetic comprising:
a prefabricated resin, full arch dental prosthetic body having a dentate portion, a terminal occlusal surface and a terminal intaglio surface;
a rigid resin fence affixed to said intaglio surface of said prosthetic body; said rigid fence having a plurality of implant sockets corresponding to said embedded dental implants; each of said implant sockets having a depth less than a length of said head portion of said respective embedded dental implant; and
a gingival resin veneer affixed to said prosthetic body and said rigid fence.

10. The dental prosthetic of claim 9 wherein said rigid fence is firmly affixed to said intaglio surface of said prosthetic body using a curable dental resin.

11. The dental prosthetic of claim 9 wherein said implant sockets of said rigid fence are affixable to said embedded dental implants using a curable dental resin.

12. The dental prosthetic of claim 9 wherein said gingival veneer is firmly affixed to said prosthetic body and said rigid fence using a curable dental resin.

13. The dental prosthetic of claim 12 wherein said prosthetic body, said rigid fence and said gingival veneer are blended and finished to form a unitary, fixed, implant-supported, full arch dental prosthetic.

14. The dental prosthetic of claim 9 wherein said prosthetic body further comprises a gingival flange intermediate of said dentate portion and said intaglio surface.

15. The dental prosthetic of claim 9 wherein said gingival veneer is tapered in order to increase a clearance between said dental prosthetic and said patient's gingival tissue.

16. A dental kit, comprising:
at least one prefabricated resin rigid, full arch dental prosthetic body being arcuate in form and constructed from a cured dental resin; said prosthetic body having a dentate portion, a terminal occlusal surface and a terminal intaglio surface; and
a supply of at least one curable dental resin.

17. The dental kit of claim 16 wherein said dental prosthetic body is a plurality of dental prosthetic bodies.

18. The dental kit of claim 17 wherein said plurality of dental prosthetic bodies have varying shapes and sizes.

19. The dental kit of claim 17 wherein said dentate portions of said plurality of dental prosthetic bodies have varying tooth shapes and forms.

20. The dental kit of claim 16 wherein said prosthetic body further comprises a gingival flange intermediate of said dentate portion and said intaglio surface.

21. The dental kit of claim 16 wherein said cured dental resin is a composite resin, a hybrid composite resin, a nanohybrid composite resin, a micro-filled composite resin, a flowable composite resin, an unfilled resin or a combination thereof.

22. The dental kit of claim 16 further comprising at least one implant analog, at least one dental implant having a head portion and a threaded shank portion, a supply of wax, a supply of shellac or a combination thereof.

23. A method of firmly affixing a full arch dental prosthetic to an array of dental implants embedded into a patient's jaw, where said array of dental implants each have a head portion exposed above said patient's gingival tissue and a threaded shank portion embedded and anchored within said patient's jawbone, said method comprising the steps of:
(a) selecting a prefabricated, rigid, full arch dental prosthetic body constructed from a cured dental resin; wherein said prosthetic body has a dentate portion, a terminal occlusal surface and a terminal intaglio surface;
(b) constructing a resin fence having a plurality of implant sockets corresponding to said array of dental implants;
(c) curing said resin fence;
(d) firmly affixing said resin fence to said intaglio surface of said dental prosthetic body; and
(e) firmly affixing said implant sockets to said array of dental implants embedded into said patient's jaw.

24. The method of claim 23 wherein said step (b) further comprises constructing said resin fence along an array of implant analogs on a working model.

25. The method of claim 24 further comprising constructing a sub-fence along a gingival line of said working model; and wherein said sub-fence has a height less than a length of an exposed head portion of said implant analogs.

26. The method of claim 25 further comprising constructing said resin fence such that each of said implant sockets has a depth less than a length of said head portion of said respective dental implant.

27. The method of claim 23 wherein said step (d) further comprises the steps of firmly affixing said resin fence to said intaglio surface of said dental prosthetic body using a curable dental resin and curing said dental resin.

28. The method of claim 23 wherein said step (e) further comprises the steps of firmly affixing said implant sockets to said head portion of said array of dental implants using a curable dental resin and curing said dental resin.

29. The method of claim 23 further comprising the steps of constructing a gingival veneer from a curable dental resin along said resin fence and said dental prosthetic body and curing said gingival veneer to said resin fence and said dental prosthetic body.

30. The method of claim 29 further comprising the step of blending and finishing said dental prosthetic body, said resin fence and said gingival veneer.
